(19) United States
(12) Patent Application Publication
(10) Pub. No.: US 2021/0133629 A1
(43) Pub. Date: May 6, 2021

(54) Coastal Aquatic Conditions Reporting System Using A Learning Engine

(71) Applicants: Alex N. Beavers, JR., Bradenton, FL (US); Michael P. Crosby, Sarasota, FL (US)

(72) Inventors: Alex N. Beavers, JR., Bradenton, FL (US); Michael P. Crosby, Sarasota, FL (US)

(73) Assignee: Mote Marine Laboratory, Sarasota, FL (US)

(21) Appl. No.: 17/079,516

(22) Filed: Oct. 25, 2020

Related U.S. Application Data
(60) Provisional application No. 62/926,135, filed on Oct. 25, 2019.

(51) Int. Cl. G06N 20/00; G06Q 50/26

(52) U.S. Cl. CPC G06N 20/00; G06Q 50/26

(57) ABSTRACT

The present invention relates to a software system that incorporates a digital learning engine comprised of machine learning algorithms that efficiently speeds up and expands the extraction of practically useful information from massively large data sets of observations and measurements of coastal aquatic environmental and human health conditions for the purpose of planning and implementing sustainable, preventative or mitigation actions by commercial, consumer, citizen, government, and research organizations.

### CROSS-REFERENCE TO RELATED APPLICATIONS

This application is a nonprovisional application for a utility patent which claims priority from and the benefit of U.S. Provisional Application Ser. No. 62/926,135, entitled “Coastal Marine Conditions Reporting System Using A Learning Engine,” filed Oct. 25, 2019. Each of the foregoing applications is hereby incorporated by reference.

### STATEMENT REGARDING FEDERALLY SPONSORED RESEARCH OR DEVELOPMENT

(Not Applicable)

### REFERENCE TO SEQUENCE LISTING, A TABLE, OR A COMPUTER PROGRAM LISTING COMPACT DISC APPENDIX

(Not Applicable)

### BACKGROUND OF THE INVENTION

### Field of the Invention

The present invention relates to the field of monitoring, reporting, and researching the environmental conditions on or near the coasts, shore, or beaches of aquatic areas including freshwater, saltwater, and brackish water habitats.

### Description of the Related Art

The capacity and capability of conventional manual and computer techniques for the processing and analysis of the threats to coastal aquatic conditions data for the purpose of planning and implementing sustainable, preventative, mitigation, or remediation actions by commercial, consumer, citizen, government, and research organizations is being exceeded by the size and increasing growth rate of the raw data being collected. Currently there is no platform or consolidated system that integrates wide varieties of data, that applies machine learning technology to automate and increase the productivity of the integration and analysis of the data, and that generates new action plans for improving the prevention, mitigation, and remediation of threats to coastal aquatic conditions habitats.

### SUMMARY OF THE INVENTION

Water is fundamental to life and human activity. The global population is concentrated near bodies of fresh, salt, and brackish water. The United Nations estimates that 40% of the world's population lives within 100 km of ocean coastal areas and the vast majority of the remainder of the population lives with 100 km of other bodies of water such as rivers, streams, and estuaries. Defining coastal aquatic areas to include the coasts, shore, or beaches of bodies of fresh, salt, and brackish water, it is clear that the world economy and food supply chain is built on and around coastal aquatic areas.

As the global population and the global economy have grown and as environmental conditions have changed, there are growing threats to the quality of human life and health. The threat to the aquatic environment takes many forms such as pollution from chemical, plastics, and other debris, increases in temperature and acidity and decreases in oxygen content, increases in sea level, declining levels of aquatic animal and plant life, and increases in harmful blooms of algae. Many governments, non-governmental organizations, public and private organizations have launched growing efforts to measure, monitor, conduct mitigation experiments, and revise behaviors with the goals of understanding and addressing these threats. As more technology and public attention is applied with these two goals, the amount of data being collected is growing rapidly and becoming so massive that it creates significant opportunities and challenges. The opportunities include learning about how to make the global economy and population sustainable. The challenges include how to handle, analyze, and learn from the massive amounts of data being collected.

There are at least two basic challenges facing commercial, consumer, government, public, private, and research organizations about coastal aquatic conditions.

The first of the challenges if to create a deeper understanding of the relationships of natural and human factors that contribute to the causes, prevention, mitigation, and remediation of the threats to coastal aquatic conditions. There has been a significant increase into the use of a wide variety of technologies such as satellite-based sensors, drone platforms, surface and subsurface sensor platforms, and mobile devices in the hands of professional research, public interest, and government organizations as well as the public to collect and report data about the conditions on, in, or near bodies of water. This is producing a massive and rapidly increasing amount of data that needs to be analyzed and converted into useful information about the causes, prevention, mitigation, and remediation of the threats being discovered. While the growing amount of new data is expanding the archive of potentially useful data, there is a growing need for new and expanded methods for efficiently and effectively analyzing and learning from the data.

Multi-dimensional, multi-sourced, multi-media data is being collected by a wide variety of a growing number of sensors and sources (Ref. 1-26). The growing amount of data is outstripping the ability of conventional techniques to process it and convert it into useful, actionable information products. For example, data is being collected by acoustic sensors of the underwater sounds generated by weather, animal, and human, by fluidic and optical sensors of underwater microscopic manmade materials and plant and animal life, by human observational measurements of surface conditions, and by satellite systems of surface and weather conditions. The types of sensors and platforms collecting data include a wide range of stationary, active, passive, autonomous, manual, automated, and mobile platforms.

The second challenge is in what to do to prevent, mitigate, or remediate the threats to coastal aquatic areas. Because the economic, social, marine, and healthcare impact of each threat has become economically significant, there has been a growing number of companies, new and established, who are offering and marketing products and/or services designed to eliminate, reduce, or prevent the negative impact of such threats. This growth trend in new products and services is creating a growing amount of hypothesized, marketed, and speculated expectations as well a growing amount of experimental, testing, and operational performance data. There are few conventional methods, techniques, or organizations that are integrating, analyzing, and reporting information on how well and when new products and services work and what their cost effectiveness might be.

The list of users of this data is growing as well. The list ranges from government agencies who have responsibilities for reporting, mitigating, and remediating threats to coastal aquatic areas, to consumers whose livelihood or recreation are affected by these threats, to businesses that are affected by these threats, and to research organizations who study the causes, effects, and possible elimination of these threats.

While the amount of data being captured is growing rapidly and the demand for useful information is growing rapidly, the problem is that there are few technical solutions for converting the massive amounts of data into practically useful information about solutions, beneficial processes, and effective procedures.

The purpose of this invention is to unlock the information potential about the causes, effects, and relationships of the threats to coastal aquatic areas that may be available in the massively growing amounts of data being collected by a wide variety of people and organizations to serve the needs of researchers, government, consumers, and business.

Conventional techniques used by organizations that produce information about coastal aquatic conditions consist primarily of electronic platforms (web sites, mobile apps, radio and television reports, text blasts, email newsletters, etc.) that publish mostly raw data observations with manually inserted alert messages where appropriate. Reporting is extensive and broadly available but is disconnected, uneven in its quality, and often misinterpreted by the people and organizations that want to use it. Some reports cover weather conditions, some cover water conditions, some cover recreational conditions, some cover fishing conditions, some cover health conditions, etc. And the reports tend to be based on conditions as observed at the particular reporting period. Due to the massive amounts of data and the uneven quality or format of data, there are significant challenges in integrating data across time, geography, or altitude. There is a need for more effective or convenient methods or tools for combining all these sources of information and to learn from successes or failures of different combinations of parameters.

The present invention is an innovation and improvement over existing methods because it integrates data from many sources, speeds up analysis by orders of magnitude, and scales up the scope of learning from massive amounts of coastal aquatic conditions data in ways that have never been done before. The novelty of the invention is that it uses machine learning computational techniques and algorithms to process and analyze data sets from a variety of sensor and organizational sources and for a variety of phenomena. The product of such data set analysis by the machine learning algorithms is information in the form of what is called herein a set of policies. These policies comprise guidelines, best practices, mitigation and remediation products and procedures, and other forms of information about how a threat to coastal aquatic conditions can be legally and effectively addressed by people and organizations. The learning engine comprises a library of machine learning algorithms that include a combination of supervised and unsupervised learning methods that have been developed by academic and commercial organizations and are applied according to the nature, source, and quality of the raw data sets.

The net benefit of the use of the invention is to provide new discoveries to researchers and effective policies about the prediction, prevention, mitigation, and remediation of threats to coastal aquatic areas, new information that is valuable to and useful to businesses who make business decisions based on this information, to consumers who make recreational and buying decisions, government organizations that make enforcement, mitigation, and remediation decisions, and to researchers who make experimental program decisions.

### BRIEF DESCRIPTION OF THE DRAWINGS

FIG. 1 is Block Diagram of an embodiment of the layering of data across time, space, and measurable or observable phenomena.

FIG. 2 is a Block Diagram of an embodiment for a Coastal Aquatic Conditions Reporting System Using a Learning Engine.

FIG. 3 is a Block Diagram of an embodiment of Data Sources for a Coastal Aquatic Conditions Reporting System Using a Learning Engine.

FIG. 4 is a Block Diagram of an embodiment of a Learning Engine for a Coastal Aquatic Conditions Reporting System.

FIG. 5 is a Block Diagram of an embodiment of a Master Knowledge Base for a Coastal Aquatic Conditions Reporting System.

FIG. 6 is a Block Diagram of an embodiment of a Data Cleaner for a Coastal Aquatic Conditions Reporting System.

FIG. 7 is a Block Diagram of an embodiment of a Learning Module for a Coastal Aquatic Conditions Reporting System.

FIG. 8 is a Block Diagram of an embodiment of a Library of Learning Algorithms for a Coastal Aquatic Conditions Reporting System.

FIG. 9 is a Block Diagram of an embodiment of a User Interface for a Coastal Aquatic Conditions Reporting System.

### DETAILED DESCRIPTION OF THE INVENTION

One or more specific embodiments of the present disclosure are described below. When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

The embodiments described herein relate to a computer implemented method that includes a digital learning engine comprised of machine learning algorithms that economically scales up and speeds up the processing of massively large data sets of observations and measurements of coastal aquatic conditions to produce practically useful information in the form of what is called herein a set of policies. These policies comprise guidelines, best practices, mitigation and remediation products, procedures and processes, and other forms of information about how a threat to a coastal aquatic area can be legally and effectively addressed by people and organizations.

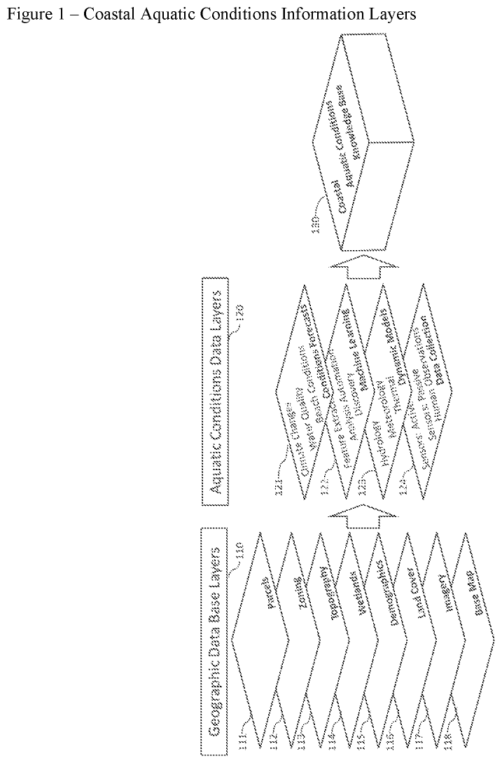

FIG. 1 is Block Diagram of an embodiment of the layering of coastal aquatic condition data and other relevant data across time, space, and measurable or observable phenomena but which are collected, stored, managed, and analyzed in a wide variety of places by a wide variety of organizations. There is a massive amount of information in geographic information systems (GIS) created and managed by federal, state, and local government organizations that are organized in Geographic Data Base Layers 110. These layers include Land Parcels 111, Zoning 112, Topography 113, Wetlands 114 that include information about coastal aquatic areas, population and building density data in Demographics 115, indications of Land Cover 116 such as natural, agriculture, landscaping, digital pictures from overhead cameras in Imagery 117, and roads and natural features in Base Maps 118. The Wetlands 114 layers in most GIS are usually limited to geographic features.

New data that has been growing massively in volume of collection and in breadth of phenomena in the category of Aquatic Conditions Data Layers 120. The growing variety of technology-based Data Collection 124 platforms include active sensors, passive sensors, and human observations. There are a variety of Dynamic Models 123 that include hydrological, meteorological, and thermal computer models that are being developed and used in research organizations that are generating new data about the relationships of aquatic conditions inputs to outputs. There are expectations that Machine Learning 122 techniques that have been developed and applied to commercial applications such as retailing, cybersecurity, and games can be applied to the wide variety of coastal aquatic conditions data. The usefulness of the information from the analysis and learning from all of these data layers will be determined by the value and quality of Conditions Forecasts 121 for various natural and physical phenomena of coastal aquatic areas.

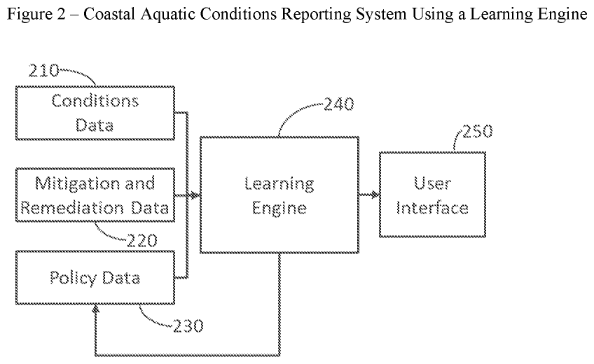

FIG. 2 is a Block Diagram of an embodiment of Coastal Aquatic Conditions Reporting System Using a Learning Engine. The system receives and stores at least three digital libraries of data: Conditions Data 210 from sensors and human observations, Mitigation and Remediation Data 220 from government, commercial, and public sources, and Policy Data 230 from government, commercial, and public sources and from the Learning Engine 240. The Learning Engine 240 processes new or historical data from the three digital libraries, learns from it, and creates new or improved polices that are used to update the Policy Data 230 library. The system also includes a User Interface 250 that provides information from the Learning Engine 240 or from the three digital libraries 210, 220, or 230 to either human or machine users.

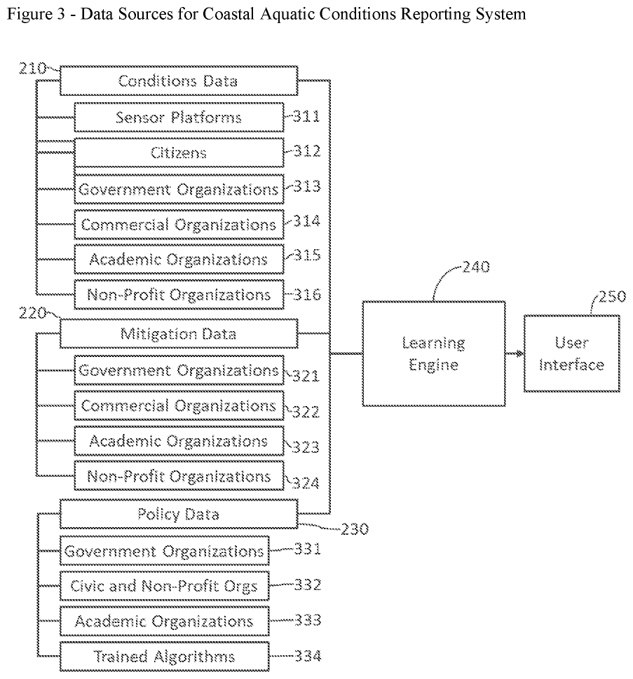

FIG. 3 is a Block Diagram of an embodiment of Data Sources for the Coastal Aquatic Conditions Reporting System Using a Learning Engine. There are several data sources that feed the digital library of the Conditions Data 210. One group of sources includes Sensor Platforms 311 such as instrumented space craft, airborne vehicles, surface borne vehicles, underwater vehicles whether they are drones or human operated, and stationary platforms such as on buoys, piers, buildings, or towers. Another data source includes Citizens 312 who are people that record their observations of conditions in the form of digital images, voice recordings, or air or water quality with their own instruments or personal digital products such as cell phones. A third data source includes Government Organizations 313 at the federal, state, and local levels. A fourth data source includes Commercial Organizations 314 that maintain data bases or produce data products that describe the conditions or threats to coastal aquatic conditions in various geographic areas. A fifth data source includes Academic Organizations 315 that perform research, deliver educational courses, or maintain data bases or produce data products that describe the conditions of or threats to coastal aquatic conditions in various geographic areas. A sixth data source includes Non-Profit Organizations 316 that perform research, deliver educational courses, or maintain data bases or produce data products that describe the conditions of or mitigation approaches for threats to coastal aquatic conditions in various geographic areas.

There are several data sources that feed the digital library of the Mitigation Data 220. One group of sources are Government Organizations 321 at the federal, state, and local levels. A second data source includes Commercial Organizations 322 that maintain data bases or produce data products that describe mitigation or remediation approaches for coastal aquatic conditions in various geographic areas. A third data source includes Academic Organizations 323 that perform research, deliver educational courses, or maintain data bases or produce data products that describe mitigation or remediation approaches for threats to coastal aquatic conditions in various geographic areas. A fourth data source includes Non-Profit Organizations 324 that perform research, deliver educational courses, or maintain data bases or produce data products that describe mitigation or remediation approaches for threats to coastal aquatic conditions in various geographic areas.

There are several data sources that feed the digital library of the Policy Data 230. One group of sources are Government Organizations 331 at the federal, state, and local levels that perform research, deliver educational courses, or maintain data bases that describe products, practices, guidelines, principles, or legal constraints for mitigation or remediation approaches for threats to threats to coastal aquatic conditions in various geographic areas. A second data source includes Civic and Non-profit Organizations 332 that maintain data bases or produce products that describe practices, guidelines, principles, or legal constraints for using mitigation or remediation products for threats to coastal aquatic conditions in various geographic areas. A third data source includes Academic Organizations 323 that perform research, deliver educational courses, or maintain data bases or produce data products that describe products, practices, guidelines, principles, or legal constraints for mitigation or remediation approaches for threats to coastal aquatic conditions in various geographic areas. A fourth data source includes Trained Algorithms 324 that have been created or modified by the Learning Engine 240 that describe products, practices, guidelines, principles, or legal constraints for mitigation or remediation approaches for threats to threats to coastal aquatic conditions in various geographic areas.

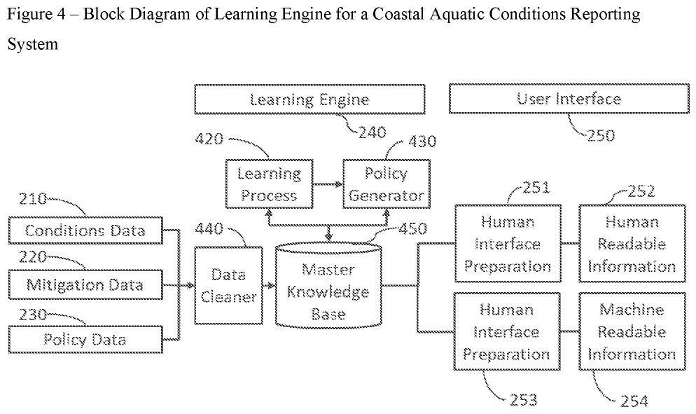

A Block Diagram of an embodiment of a Learning Engine 240 for a Coastal Aquatic Conditions Reporting System is shown in the block diagram in shown in FIG. 4. At the heart of the Learning Engine 240 is a Master Knowledge Base 450 which is the digital archive of all layers of Conditions Data 210, Mitigation Data 220, and Policy Data 230, the Learning Algorithms 420 where all the machine learning algorithms are stored and applied, and the Policy Generator Module 430 where all the policies for a Coastal Aquatic Conditions Reporting System are created and stored. The Learning Engine 240 includes a Data Cleaner 440 that corrects, converts, and reformats data received from Conditions Data 210, Mitigation Data 220, and Policy Data 230. The Learning Engine 240 communicates with humans and machines through the User Interface 250.

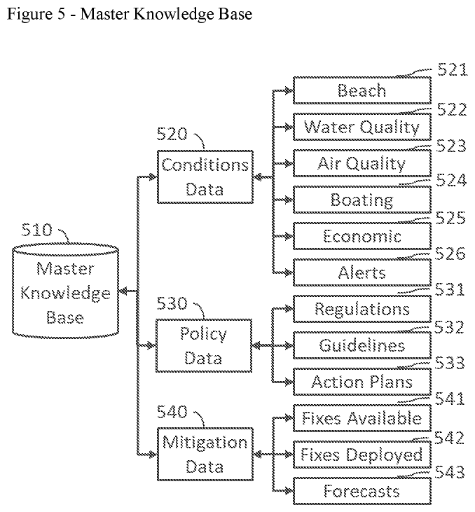

An embodiment of the Master Knowledge Base 510 for the Learning Engine 240 of the Coastal Aquatic Conditions Reporting System is shown in the block diagram in FIG. 5. The Master Knowledge Base 510 includes the storage of Conditions Data 520, Policy Data 530, and Mitigation Data 540. Conditions Data 520 includes Beach Data 521 that includes waterfront, beach, and shore conditions, Water Quality Data 522, Air Quality Data 523, Boating Data 524, Economic Data 525, and Alerts Data 526. Policy Data 530 includes Regulations Data 531, Guidelines Data 532, and Action Plan Data 533. The Mitigation Data 540 includes Fixes Available 541 that describes mitigation or remediation solutions, products, and procedures that are available, Fixes Deployed 542 that describes mitigation or remediation solutions, products, and procedures that are being deployed by various organizations, and Forecasts 543 of coastal aquatic conditions.

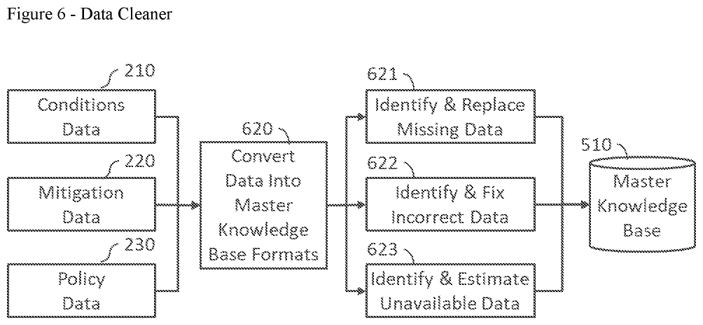

An embodiment of the Data Cleaner 440 is shown in the Block Diagram of FIG. 6. The function of the Data Cleaner 440 is to take raw data from the various sources and types of data such as Conditions Data Sources 210, Mitigation Data Sources 220, and Policy Data Sources 230 and Convert Into Master Knowledge Base Formats 620. The function of cleaning data is necessary because data from the wide variety of sources often have problems that need to be identified, corrected, or annotated before they can be used by the Learning Algorithms or added to the Master Knowledge Base. Data problems occur because data formats for instruments and machines are not uniform, measurements made by machines as well as humans are contaminated in part with random noise, observational and technical biases, measurement data rates have different frequencies, amplitudes of measured values may not be absolute, and a variety of other problems. After the format conversion is completed, then the data cleaning process includes the steps of Identify and Replace Missing Data 621, Identify and Correct Incorrect Data 622, and Identify & Estimate Missing Data 623.

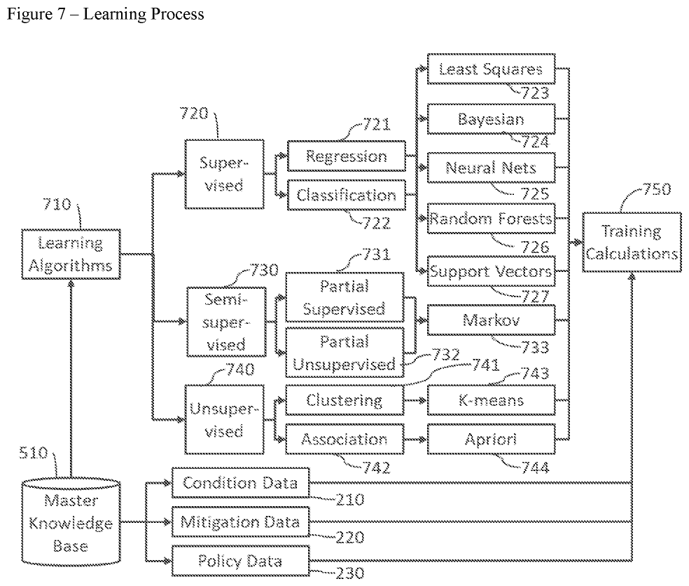

An embodiment of the Learning Process 420 is shown in the Block Diagram of FIG. 7. The Learning Process 420 comprises a library of machine Learning Algorithms 710, data sets from Conditions Data 210 sources, Mitigation Data 220 sources, or Policy Data 230 sources all contained with the Master Knowledge Base 510. During Training Calculations 750 one or more of the algorithms from the Learning Algorithms 710 digital library are used to determine whether the profiles in the Policy Data 230 need to be updated, modified, or new profiles created. The output of Training Calculations 750 is either new or updates to Policy Data 230 sets stored in the Master Knowledge Base 510. As described above, each policy in Policy Data 230 is a profile of action steps contained within Regulations 531, Guidelines 532, or Action Plans 533 for mitigating coastal aquatic conditions for specific algae species and for specific geographic and water conditions. The machine learning algorithms that reside in the digital library Learning Algorithms 710 include Supervised 720 algorithms, Unsupervised 740 algorithms, and Semi-supervised 730 algorithms.

The Supervised 720 digital library of algorithms includes Regression 721 algorithms and Classification 722 algorithms. Supervised machine learning generally refers to the use of human experts to define the types of models or labels to be trained by data sets. In essence, a machine learning algorithm is supervised by a human expert as it calculates the best matches based on the data the algorithm is presented.

The algorithms in the Regression 721 digital library can be chosen from a variety of sources. Regression 721 algorithms are designed to calculate coefficients for a polynomial that produces a best fit between the polynomial equation and many sets of data. This best fit polynomial then becomes the new or updated model for a Plan which is a set of Rules for how to grow a specific species in a specific facility. The calculations and simulations used to determine the best fit model is the training process for the new or updated Plan or set of Rules.

The algorithms in the Classification 722 digital library can be chosen from a variety of sources. Classification 722 algorithms are designed to split data into categories which have labels that have been discovered or predefined by human experts. There are a variety of classification algorithms which use different types of equations to determine best fit within a classification.

The mathematical approaches that can be used in Supervised 720 algorithms for both Regression 721 and Classification 722 applications include Least Squares 723, Bayesian 724, Neural Nets 725, Random Forests 726, and Support Vectors 727. Least Squares 723 algorithms compute the coefficients for a polynomial that makes the distance between data points and the polynomial as small as possible. In Least Squares 723 algorithms, there are no assumptions about what causes the differences between the data sets and the polynomial models. In Bayesian 724 algorithms, assumptions are included that the causes of the differences between the data sets and the polynomial models are statistical in nature. The typical assumptions in Bayesian 724 models include that the distribution is normal and that the mean and variance are known. In Neural Nets 725 algorithms, regression or classification polynomial calculations are organized as a parallel processing problem by assigning and modifying the weights or coefficients of the polynomial terms they flow through one or more hidden layers of parallel states. In Random Forest 726 algorithms, data sets are randomly selected, used to create several different decision trees often by different human experts, and then statistically merged or averaged together to produce a set of coefficients for matching polynomials or categories. In Support Vectors 727 machines, the approach to classifying sets of data is to calculate a polynomial model surface that separates the categories of data best rather than calculating a polynomial surface that fits the data within a category best. The coefficients of the polynomial that describes the separating plane can be represented as a vector in matrix algebra.

The Unsupervised 740 digital library of algorithms includes Clustering 741 algorithms and Association 742 algorithms. Unsupervised 740 algorithms are called unsupervised because an assumption is made that there is no set of labels or categories predefined by human experts that can be used to supervise, guide, or set the starting point for the machine learning calculations. Unsupervised machine learning algorithms are sometimes called data mining algorithms because the algorithms are mining or searching for some unknown classifications or labels from raw data.

Clustering 741 machine learning algorithms include the use of mathematical techniques for grouping a set of data in such a way that data in the same group (called a cluster) are more similar (in some calculable sense) to each other than to data in other groups (clusters). Because the clustering approach is unsupervised, it usually requires several iterations of analysis until consistently clear categorizations and groupings can be identified from the data sets being analyzed.

The Clustering 741 digital library includes the K-means 743 algorithm. The approach of K-means 743 algorithms is based on calculating the average distance between the centroid of K clusters in a dataset. At the start of the analysis, a number is chosen for K. Every data point is allocated to each of the K clusters through reducing the in-cluster sum of squares difference from each of the centroids. This process is iterative and takes several steps to correct each centroid location and minimize the sum of squares of the distances from the data points in each cluster to the centroid. Then a lower value of K and a higher value of K can be chosen to see if either of those numbers of clusters produces a lower mean or tighter fit. The iterations end when a value of K is found which produces the lowest sum of squares difference.

Association 842 machine learning algorithms include the use of correlation calculations to identify important relationships between categories or clusters of items in a data set. Relationships discovered by association machine learning algorithms can be used to generate new labels or categories for additional machine learning algorithm calculations. Apriori 742 is a digital library of algorithms that search for a series of frequent sets of relationship in datasets. For example, assume that a data set has five categories identified such as A, B, C, D, and E and that an association algorithm has identified a relationship between category A and B (e.g. if a data set has data in category A, 50% of the time it has data in a category B). An Apriori algorithm might find that if a data set has data in categories A and B, it has data in Category C 80% of the time.

Because it is not always possible to have data sets that can be analyzed with Supervised 720 algorithms and because it is sometimes expensive and difficult to use only Unsupervised 740 algorithms, an approach which speeds up the analysis process is to use a Semi-supervised 730 approach to using machine learning algorithms. The Semi-supervised 730 learning approach consists of a two-step process whereby a small amount of data is used to train in a Partial Supervised 731 approach which is then combined with a large amount of data used in a Partial Unsupervised 732 approach. Markov 733 algorithms and can then be applied to complete the training calculations of the Semi-supervised approach.

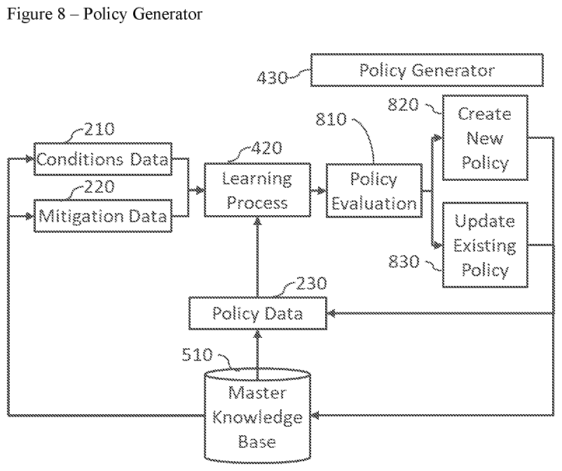

An embodiment of the Policy Generator 430 is shown in the Block Diagram in FIG. 8. The product of the Learning Process 420 is one or more policy profiles that have been trained by the machine Learning Algorithms 710 digital library using new or previously unused data the Conditions Data 210 and Mitigation Data 220. When a newly trained policy profile is produced, a Policy Evaluation 810 is performed to determine if Create New Policy 820 is required or if Update Existing Policy 830 is required. In either case, the new or updated policy profile is added to the Policy Data 230 digital library in the Master Knowledge Base 510.

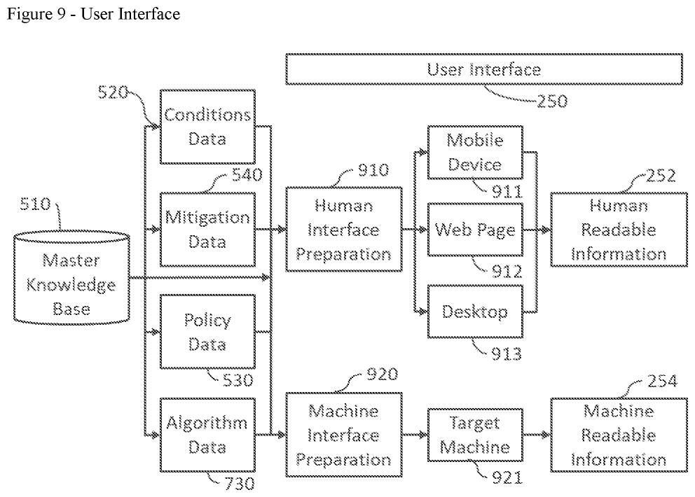

An embodiment of the User Interface 250 is shown in the Block Diagram in FIG. 9. The User Interface 250 supports the delivery of Human Readable Information 252 and Machine-Readable Information 254. Machine Readable Information 254 represents the data and information exchanged electronically between the instruments, equipment, and machines that are installed through an electronic network. The Human Interface Preparation 910 module manages the format and exchange of information between the Master Knowledge Base and Human Readable Information 252 through the Mobile Device 911, Web Page 912, and Desktop 913. The Machine Interface Preparation 920 module converts the Machine-Readable Information 254 being communicated to the proper format for the Target Machine 921.

The invention claimed is:

1. A computer implemented method that uses machine learning algorithms to process massive amounts of data about air, water, land, wildlife, and human health conditions near coastal aquatic areas from a wide variety of sources from a wide range of geographic areas to produce alerts, guidelines, policies, and recommendations for the mitigation or remediation of coastal conditions comprising:
A library of data sets that describe coastal conditions which can be used for the purpose of planning and implementing sustainable, preventative or mitigation actions by commercial, consumer, citizen, government, and research organizations. data sets that describe specific conditions about air, water, land, wildlife, and human health for specific geographic areas;
A library of data sets that describe products which includes methods and practices that have been proven to assist in the prevention, mitigation, or remediation of Coastal Aquatic Conditions;
A library of data sets that define policies which detail how to detect, how to report, when and how to send alerts, how to select mitigation or remediation products, methods, and practices, and how to be compliant with local, state, and federal laws and rules for dangerous water A library of machine learning algorithms that can be used to create, teach, and update specific policies for Coastal Aquatic Conditions by using new or existing data sets from the libraries of data sets for specific conditions, mitigation products, and policies;
A learning engine wherein a machine learning algorithm is selected from the library of machine learning algorithms and then used to train, update, or create a policy by calculating the best fit of data from data sets selected from the libraries of data sets for specific conditions, mitigation products, and policies to the algorithm mathematical equations; and
A user interface that provides reports and policy action data electronically to a human user or to a computer-controlled machine.
The method of claim 1, wherein the geographic areas comprise bodies of fresh water and the associated variety of fresh water Coastal Aquatic Conditions.

2. The method of claim 1, wherein the geographic areas comprise bodies of salt water and the associated variety of salt water Coastal Aquatic Conditions.

3. The method of claim 1, wherein the geographic areas comprise bodies of water where there are flows of both freshwater and saltwater and the associated variety of Coastal Aquatic Conditions.

4. The method of claim 1, wherein the library of data sets of specific conditions about air, water, land, wildlife, and human health for specific geographic areas are provided by human observations aided or unaided with instrumentation or sensors.

5. The method of claim 1, wherein the library of data sets of specific conditions about air, water, land, wildlife, and human health for specific geographic areas are provided by government organizations.

6. The method of claim 1, wherein the library of data sets of specific conditions about air, water, land, wildlife, and human health for specific geographic areas are provided by nonprofit organizations.

7. The method of claim 1, wherein the library of data sets of specific conditions about air, water, land, wildlife, and human health for specific geographic areas are provided by corporations or business organizations.

8. The method of claim 1, wherein the library of data sets of specific conditions about air, water, land, wildlife, and human health for specific geographic areas are provided by research and academic organizations.

9. The method of claim 1, wherein the library of machine learning algorithms are provided by government organizations.

10. The method of claim 1, wherein the library of machine learning algorithms are provided by nonprofit organizations.

11. The method of claim 1, wherein the library of machine learning algorithms are provided by corporations or business organizations.

12. The method of claim 1, wherein the library of machine learning algorithms are provided by research and academic organizations.

13. The method of claim 1, wherein the user interface provides data electronically to a mobile electronic device.

14. The method of claim 1, wherein the user interface provides data electronically to a stationary or desk top electronic device.

15. The method of claim 1, wherein the user interface provides data electronically to one or more electronic devices directly or through an electronic network.
